(19) United States
(12) Patent Application Publication
(10) Pub. No.: US 2005/0226973 A1
(43) Pub. Date: Oct. 13, 2005

(54) Process for treating edible plant structures and product thereof

(76) Inventors: Rodney Lingham, Rupanyup (AU); Robert Greig, Ballarat (AU)

Correspondence Address: STEVENS & SHOWALTER LLP, 7019 CORPORATE WAY, DAYTON, OH, 45459-4238, US

(21) Appl. No.: 10/819,488

(22) Filed: Apr. 7, 2004

(51) Int. Cl. A23L 1/00

(52) U.S. Cl. 426/324

(57) ABSTRACT

The present invention relates to a process, a treatment solution and the product resulting from the process, which extends the shelf life of edible plant structures. The exposed edible plant structure is treated by applying a treatment solution to a comprising at least one antioxidant, at least one mineral salt, at least one organic acid and water; in a manner which impregnates the treatment solution into the exposed edible plant structure. This produces a treated edible plant structure having an extended shelf life. Preferably, the treated edible plant structure is thereafter sealed within a container containing a negligible amount of oxygen. The process of the present invention results in a treated edible plant structure which can be stored for relatively long periods of time, in comparison with untreated edible plant structures, without substantially deteriorating.

### The Field of the Invention

The present invention generally relates to a process for treating edible plant structures, a treatment solution for treating edible plant structures and a product resulting from the process and/or treatment. More particularly, the present invention relates to a process, a treatment solution used in the process and a product resulting from the process, which extends the shelf life of edible plant structures so that such edible plant structures can be stored for relatively long periods of time without substantially deteriorating.

### BACKGROUND

Edible plant structures can include any agricultural or horticultural products or part thereof that can be eaten. Many edible plant structures such as fruit, vegetables or the like, typically have a short shelf life when fresh and untreated. The shelf life is further shortened if the edible plant structure is exposed wherein the outer layer of tissue or skin normally covering the edible plant structure is removed. The outer skin layer may be removed by peeling, breaking, cutting, scratching or otherwise damaging this skin layer. In the exposed state, an edible plant structure can be more susceptible to deterioration process such as for example oxidation of the plant structure when contacted with an atmosphere or the like which promotes discolouration of the plant structure.

It is therefore desirable to extend the shelf life of edible plant structures when such edible plant structures are required to be stored for long periods of time, for example during transport, distribution processes, stock piling, retailing or the like. Traditionally, chemical preservatives have been used in treatment processes to extend the shelf life of edible plant structures. For example, in the case of potatoes, preservatives containing sulfite compounds such as sodium meta bisulphite are typically used. Sodium meta bisulphite reduces the degradation processes such as browning of the exposed surface of the potato. However, preservative chemicals such as sodium meta bisulphite give the potato an unpleasant sulphur like odour. Sulfite has also been linked to illnesses, mainly among asthmatics.

Therefore, an alternative treatment process to sodium meta bisulphite which overcomes the odour and undesirable side effects of existing processes would be an important advancement in the vegetable and food processing industry in general.

Thus, it is an aim of the present invention to provide a treatment, process method or the like which extends the shelf life of an edible plant structure without there being any adverse effects, such as poor texture, offensive odour or the like.

It is to be understood that in the context of this specification that the term “edible plant structure” is used herein in its broadest sense and includes all edible plant structures such as fruit, vegetables, roots or the like, including parts thereof.

Furthermore, the term “shelf life” is used herein in its broadest sense to mean the period of time that an edible plant structure, can be stored without the edible plant structure's properties such as flavour, colour or texture substantially deteriorating, particularly to the point where the plant structure has little or no commercial value.

The term “exposed edible plant structure” is used herein in its broadest sense and includes the tissue or part of the tissue normally covered by the outer layer of the edible plant structure which is exposed when the edible plant structure is peeled, damaged, cut or otherwise exposed. However, it is to be understood where an edible plant structure is not normally peeled, damaged, cut or otherwise exposed during conventional processing operations, such as processing asparagus, leeks or the like, the term exposed may be used to cover these edible plant structure also.

### SUMMARY OF THE INVENTION

According to the present invention there is provided a treatment solution for extending the shelf life of an exposed edible plant structure when impregnated into the exposed edible plant structure, the treatment solution comprising at least one antioxidant, at least one mineral salt, and at least one organic acid.

According to another aspect of the present invention, there is provided a process for treating an exposed edible plant structure, comprising the steps of
applying a treatment solution to an exposed edible plant structure, the treatment solution comprising at least one antioxidant, at least one mineral salt, and at least one organic acid; and
impregnating the treatment solution into the exposed edible plant structure,
   thereby producing a treated edible plant structure having an extended shelf life.

According to another aspect of the present invention, there is provided a process for treating an exposed edible plant structure, comprising the steps of:
applying the treatment solution according to claim 1 to an exposed edible plant structure, the treatment solution comprising at least one antioxidant, at least one mineral salt, and at least one organic acid;
creating a partial vacuum around the exposed edible plant structure thereby impregnating the treatment solution into the exposed edible plant structure thereby forming a treated edible plant structure;
sealing the exposed edible plant structure into a container substantially free of oxygen; and
substantially cooling the treated edible plant structure
   thereby producing a treated edible plant structure having an extended shelf life.

It is to be understood that the treatment solution and/or process of the present invention is preferably used with an uncooked exposed edible plant structure. This uncooked exposed edible plant structure can therefore be stored for a greater period, and then cooked, processed or otherwise prepared at a later date.

As will be understood by a person skilled in the art, many different combinations of compounds could be selected which would be suitable for use in the treatment solution. However, it is preferred that the anti-oxidant is selected from erythorbic acid, sodium erythorbate, ascorbic acid, ascorbate salts, sodium ascorbate, calcium ascorbate, potassium ascorbate, or a mixture thereof. More preferably, the anti-oxidant is ascorbic acid.

Typically, the mineral salts contain alkaline earth metal salts. It is preferred that the mineral salt is selected from calcium and/or sodium containing salts, preferably from calcium chloride or sodium acid pyrophosphate. More preferably, the treatment solution comprises two mineral salts. Even more preferably, the two mineral salts are calcium chloride and sodium acid pyrophosphate in combination with each other.

Typically, the organic acid acts as an acidity regulator in the treatment solution. More typically, the acid regulator controls the pH of the solution. More typically the acidity regulator controls the pH to a value less than 3.5, more preferably less than 2.5. It is preferred that the organic acid is selected from acetic acid, citric acid, lactic acid or a mixture thereof including precursors for and derivatives of these acids. More preferably, the organic acid is citric acid.

Preferably, the treatment solution is water based.

In one embodiment of the invention, the treatment solution includes between 0.1 to 5% sodium acid pyrophosphate and 0.1 to 10% citric acid, 0.1 to 15% ascorbic acid and 0.01 to 2% calcium chloride. Preferably, the treatment solution includes between 1 to 2% sodium acid pyrophosphate, 1 to 5% citric acid, 2 to 6% ascorbic acid and 0.1 to 0.5% calcium chloride. More preferably, the treatment solution includes between 1 to 2% sodium acid pyrophosphate, 1% citric acid, 4% ascorbic acid and 0.2% calcium chloride.

The impregnation process is preferably preceded by a step in which the outer surface of the exposed edible plant structure is applied with the treatment solution. The treatment solution may be applied to the edible plant structure by submersing the edible plant structure into the treatment solution, spraying the edible plant structure with the treatment solution, pouring the treatment solution onto the edible plant structure or a combination of these applications.

Preferably, the treatment solution is applied to the edible plant structure for a period of up to 15 minutes. More preferably, the treatment solution is applied to the edible plant structure for a period between 2 to 10 minutes. Even more preferably, the treatment solution is applied to the edible plant structure for a period between 3 to 7 minutes.

Typically, the process of treating the exposed edible plant structure is carried out under controlled temperature conditions between 10 to 15° C. Preferably, the edible plant structure is initially brought to a temperature between 10 to 15° C. prior to treatment. In some embodiments of the invention, one, two or more temperatures may be used.

It has been found that impregnation of the treatment solution into the plant structure is of considerable benefit in substantially inhibiting the processes which causes the deterioration of exposed edible plant structure. One particularly advantageous embodiment of the invention impregnates the treatment solution into the exposed edible plant structure under conditions of reduced pressure. Preferably, the treatment solution is impregnated into the treated exposed plant structure using an impregnation means which creates a partial vacuum around the exposed plant structure. The partial vacuum may be applied so that there is a (negative) pressure of between −0.8 to −0.99 bar at the surface of the edible plant structure. Preferably, the partial vacuum is applied concurrently with the application of the treatment solution. Accordingly, the reduced pressure conditions assists in penetrating the treatment solution into the plant structure so as to ensure that the treatment solution is suitably impregnated into the exposed edible plant structure.

It is preferable that once the exposed edible plant structure has been treated, the exposed edible plant structure be sealed into a container. Preferably, the treated edible plant structure is sealed within a container which is free or substantially free of oxygen or contains a negligible amount of oxygen. In this respect, oxygen can be substantially removed from the container using at least two different process:

In one embodiment of the invention, the treated edible plant structure is sealed within a container substantially free of oxygen using a further process comprising the steps:
placing the treated edible plant structure into a container;
creating a partial vacuum in the container so as to substantially remove any oxygen surrounding the treated edible plant structure; and
sealing the container,
   thereby sealing the treated edible plant structure into a container substantially free of oxygen.

Accordingly, substantially all oxygen surrounding the treated edible plant structure is removed by the applied vacuum. Preferably, the applied vacuum also impregnates the plant structure or assists in penetrating the treatment solution into the plant structure.

Preferably, oxygen or air is removed from within the container to form a partial vacuum before the container is sealed. In this way, any air containing oxygen can be substantially removed from around the treated edible plant structure.

Preferably, the partial vacuum is applied so that a pressure of less than −0.8 bar occurs inside the container prior to sealing. Preferably, the partial vacuum is applied so that a pressure of less than −0.95 bar occurs inside container prior to sealing. More preferably, the partial vacuum is applied so that a pressure of between −0.95 bar to −0.99 bar occurs inside container prior to sealing.

It is preferred that the container may be constructed of material(s) that have properties which substantially maintain the optimum low oxygen atmosphere and also substantially maintains the partial vacuum inside the container.

In another embodiment of the present invention, the treated edible plant structure is sealed within a container substantially free of oxygen using a further process comprising the steps:
placing the treated edible plant structure into a container;
substantially displacing/replacing air in the container with a non-oxygen containing gas; and
sealing the container,
   thereby sealing the treated edible plant structure into a container substantially free of oxygen.

Accordingly, any oxygen in the atmosphere surrounding the treated edible plant structure is substantially displaced with a modified atmosphere which is introduced into the container. Modified atmosphere herein refers to a gas or mixture of gases which does not include oxygen. Typically, the modified atmosphere includes nitrogen, carbon dioxide, argon, helium or any combination thereof. It is noted that gases that promote ripening of the plant are to be avoided in the interest of longevity of storage Alternatively, the air in the container can be substantially displaced/replaced with a non-oxygen containing gas by first creating a partial vacuum in the container and thereafter introducing the non-oxygen containing gas into the container.

After the container is sealed and oxygen is removed from the container, it is preferable that the sealed container is substantially cooled. The treated edible plant structure may be cooled to a temperature less than 15° C. Preferably, the treated edible plant structure is cooled to a temperature less than 5° C. More preferably, the treated edible plant structure is cooled to less than 5° C. within a 24 hour period. More preferably, the treated edible plant structure is cooled to less than 5° C. over a time period between 8 to 30 hours. Even more preferably, the treated edible plant structure is cooled to 8° C. in less than 5 hours and thereafter cooled to less than 5° C. in less than 19 hours, preferably less than 9 hours.

In a preferred embodiment of the invention the edible plant structure a potato.

The process of the present invention results in a treated exposed edible plant structure with an extended shelf life. Preferably, the treated exposed edible plant structure can be stored up to 20 or even possibly 40 days without the exposed edible plant structure substantially deteriorating.

### BRIEF DESCRIPTION OF THE DRAWING

The present invention will now be described with reference to the figures of the accompanying drawings, which illustrate a particular preferred embodiment thereof by way of non-limiting example, wherein:

FIG. 1 is a plan view representation of potatoes treated using one embodiment of the process of the present invention in which the treated potatoes are also partial vacuum sealed within a barrier bag.

### DESCRIPTION

The process of the present invention includes a number of process steps to treat an edible plant structure so as to result in a treated edible plant structure which can be stored for a relatively long period of time, in comparison to untreated edible plant structure, without the edible plant structure substantially deteriorating. The treatment process impregnates an edible plant structure with a water-based treatment solution. The water-based treatment solution is a mixture of four naturally occurring ingredients, and includes at least one antioxidant, at least one mineral salt and at least one organic acid. The shelf life of the exposed plant structure can be further extended if the treated edible plant structure is stored in refrigerated conditions. A shelf life of up to 20, possibly up to 40 days is attainable.

Without wishing to be bound by any one theory, it is believed that the treatment solution substantially inhibits processes which causes the deterioration of potatoes. Such deterioration processes include oxidation of the potato structure, which can cause textural decomposition, discolouration or browning of the potatoes surface, unpleasant odours and other undesirable sensory attributes. It is believed that the application of treatment solution to the exposed surfaces of the plant structure reduces enzymatic and non-enzymatic browning. Furthermore, a treatment solution with a pH of less than 2.5, reduces the vegetative pathogen numbers by D values (logarithmic reductions) between 0.3 and 1.5 minutes. Reduced concentrations of the components included in the treatment solution typically decrease the solution's effectiveness/lethality therefore allowing the survival of higher levels of CFU (colony forming units) during the treatment process. The duration and concentration of the application reduces the microbial load to specified acceptable levels.

The steps of a preferred embodiment of the process of the present invention are as follows:

An exposed edible plant structure, such as a peeled potato, is treated with a water-based treatment solution which is applied to the peeled potato to extend its shelf life. The treatment solution includes 2.0% sodium acid pyrophosphate as the first mineral salt, 1.0% citric acid as the organic acid, 4.0% ascorbic acid as the antioxidant and 0.2% calcium chloride as the second mineral salt. Different concentrations of these constituents can be used. However, it has been found that the shelf life of the product is reduced if the concentrations of any of the components included in the treatment solution are reduced.

The treatment solution can be applied to peeled potato using submersion means, spraying means, pouring means or any other liquid application means. It is possible that a combination of application means may be used to apply the treatment solution to the potatoes. It is to be understood that these application techniques are well known in the art and that a person skilled in the art could readily apply these techniques to treating a potato.

To allow for sufficient penetration and reaction time, the treatment solution is applied to the potatoes for a predetermined period of time. It is expected that the predetermined period of time giving optimal treatment results would vary for various types of edible plant structure. However, for potatoes, the treatment solution is typically applied for a period between 5 to 7 minutes.

The treatment process is preferably carried out under controlled temperature conditions between 10 to 15° C., using a sterile filtered water supply having the water temperature controlled using a variable temperature control. Without wishing to be bound by any one theory, it is thought that these conditions reduce degradation reactions possible on the surface of the exposed potato. However, these are preferred conditions, and are not considered restrictive. It has been found that adequate treatment results are still attainable when the treatment process is carried out under ambient conditions using a potable water supply.

The treatment solution is impregnated into the potato concurrently with the application of an impregnation means. However, it is to be understood that impregnation of the treatment solution into the potato using the impregnation means may alternatively occur after the treatment solution has been applied to the potato.

The impregnation mean is typically a partial vacuum, applied to or around the potato so that a pressure of between −0.95 and −0.99 bar results around the potato. Without being limited to any one theory, it is thought that the applied partial vacuum impregnates the anti-oxidant into the surface of the edible plant structures, and is typically at partial vacuum levels which are sufficient to cause boiling and/or foaming on the surface of the edible plant structures.

When the treatment solution is applied concurrently with an applied partial vacuum, the residual microbial counts is typically reduced to less the 10,000 CFU (colony forming units) per ml of the liquid surrounding the edible plant structure.

Thereafter, the treatment solution or part thereof is reapplied shortly before a partial vacuum is applied to the potato. It is to be understood that this step is preferable, and this step may not be used in some embodiments of the invention.

Preferably, the treatment solution reapplication process occurs once the potato is placed inside a container and the treatment solution is applied immediately after or concurrently with the potato being placed inside the container. One such method of applying the treatment solution uses a liquid dosing applicator to concurrently apply the treatment solution to the potato and the interior of the container.

The application of the treatment solution results in a treated potato. The treatment process can be followed by further process steps to further reduce the deterioration processes.

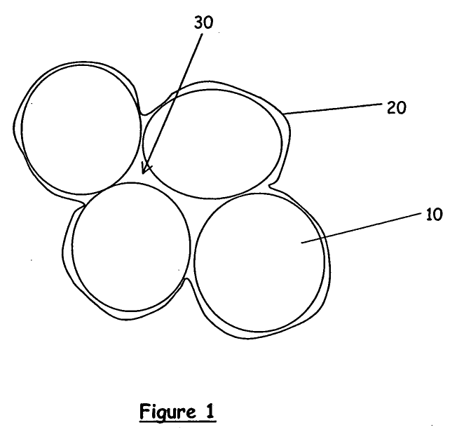

In a preferred embodiment of the present invention, illustrated in FIG. 1, the treated potato 10 is placed into a container such as an oxygen barrier bag 20. It is preferable that the barrier bag 20 is constructed of a material which has properties which substantially maintain the optimum low oxygen atmosphere for metabolism. Preferably, this material is a laminate. The barrier bag 20 is typically a 100 um partial vacuum bag 20 with barrier properties of less than 80 cc of oxygen transmission per 24 hour period per metre squared at 75% RH (relative humidity) 1 atmosphere pressure and 23° C. One supplier of a barrier bag 20 that can be used in the present invention, is Holmes Sealed Air Corporation.

Thereafter, the air surrounding the potato is substantially removed from the barrier bag 20, and the barrier bag 20 is sealed. The resulting partial vacuum 30 is at a pressure level of between −0.95 and −0.99 bar inside the barrier bag 20. The immediate sealing of the barrier bag 20 under the applied partial vacuum conditions prevents the ingress of oxygen or other gases capable of causing deterioration of the treated potato product 10.

In this manner, the sealed barrier bag 20 protects the treated potatoes 10 from being exposed to any undesirable environment which aids the deterioration process. Reducing the oxygen content in the barrier bag 20 minimises oxidation processes. Once a partial vacuum 30 has been formed inside the barrier bag 20, the barrier bag 20 is taut, wrapping around the treated potatoes 10 without evidence of the presence of gas.

The shelf life of the treated potato product can be further extended by substantially cooling the treated edible plant structure.

In another embodiment of the present invention, the treated potato product is sealed in a barrier bag 20 as previously described and then cooled to a temperature less than 5° C. Using conventional cooling means, the treated potatoes can be cooled to 8° C. in less than 5 hours and thereafter to less than 5° C. in less than 9 hours.

To further prolong the shelf life of the treated potato product, the cooled sealed barrier bag containing the treated potatoes are stored under refrigerated conditions similar to normal household refrigerator temperatures, i.e. at a temperature between 2 to 4° C.

An alternative step to applying a partial vacuum to the barrier bag involves applying a modified atmosphere to the container. The modified atmosphere may be applied during the process of placing the potatoes into the barrier, or may be applied after the potatoes are placed in the barrier bag. The treated potatoes may have a shorter shelf life by using the alternative processing step. Preferably, the modified atmosphere is a gas or mixture of gases which does not include oxygen, such as a mixture of gases including nitrogen, carbon dioxide, argon, helium or any combination thereof.

It is to be understood that further compounds commonly used as processing aids may also be included in the process of the present invention. For example, in another embodiment of the invention phosphoric acid is used as an adjunct with sodium acid pyro-phosphate. Phosphoric acid is an approved processing aid in the Australian New Zealand Food Standards Code. The addition of these compounds allows higher temperatures to be used in conjunction with lower concentrations of components in the treatment solution to achieve the same or better reductions of residual microbial counts.

### EXAMPLE

The present invention will now be described by way of the following non-limiting example.

### Example 1

### Processing Sebago Variety Potatoes

While the following example describes the steps of the process of the present invention with reference to processing Sebago variety potatoes, a person skilled in the art will appreciate that the invention described herein can be applied to any type of edible plant structures. The steps of the process when processing Sebago variety potatoes using the present invention are as follows:

After the Sebago potatoes were washed to remove adhering soil or debris, the Sebago potatoes were exposed using a peeling process.

The exposed potatoes were then treated in accordance with the process steps of the invention using a water-based treatment solution including 2% sodium acid pyrophosphate and 1% citric acid, 4% ascorbic acid and 0.2% calcium chloride. The treatment solution was applied to the potatoes by rotation and spraying in a perforated stainless steel drum with rows of sprays vertically aligned over the potatoes and then is applied in a further step where the potatoes are submerged within a rotating dipping tank device to ensure the potatoes are immersed under the surface of the treatment solution for at least 5 minutes.

Thereafter, the treated potatoes were packed into barrier bags supplied Holmes Sealed Air Corporation within cartons. The potatoes and upper level of the barrier bags were then further sprayed with the treatment solution.

Subsequently, the barrier bags containing treated potatoes are partial vacuum sealed.

The bags of treated potatoes are open stacked to allow for free passage of cool air across and around the packages. The treated potato product is cooled to 8° C. in less than 5 hours and thereafter to less than 5° C. in less than 9 hours.

FIG. 1 illustrates a packaged form of the final treated potato product produced from this process.

The treated potatoes were stored at 4° C. for 20 days. After this period of time, the barrier bags were opened and the potatoes removed. The treated potatoes were compared to freshly peeled potatoes.

On comparison of the freshly peeled potato and the treated potato, it was observed that the texture of the potato was similar, and the treated potato had no discernible discoloration or browning, or unpleasant odours.

The treated potatoes were then boiled in water with freshly peeled potatoes of the same variety. The boiled treated potatoes were then blind tested for aroma, colour, taste and texture attributes against the freshly peeled potatoes. It was found that there was no statistical difference between the potatoes that were freshly peeled and the treated potatoes at the 95% confidence level.

### Advantages

An edible plant structure such as a potato treated using the process of the present invention is found to have an advantageously extended the shelf life. Here, treated edible plant structures can be stored for relatively long periods of time without substantially deteriorating. If the treated edible plant structure is sealed within a oxygen free container and stored in refrigerated conditions, a shelf life of up to 20, possibly up to 40 days is possible.

It has also been found that the surface of a potato treated using a process of the present invention does not have any brown, grey or darkened areas after a period of storage (or shelf life). Furthermore, when a barrier bag containing the treated potato product is opened after a substantially long period of time, for example after 20 days, the treated product appears substantially free of deterioration, again not have any brown, grey or darkened areas on the treated potato surface.

Furthermore, the levels of pathogenic bacteria and toxins in the treated potato prior to cooking is typically below levels of concern to public health. Tests show that when stored the treated potatoes have a free liquid percentage of less than 10% by weight after being stored for 20 days and 20% by weight after being stored for 40 days. The free liquid percentages being defined as the residual fluid contents of the treated potatoes after removal of the whole pieces of the treated potatoes divided the total weight of the treated potatoes and expressed as a percentage.

The present invention has been advanced by explanation and many modifications may be made without departing from the spirit and scope of the invention, which includes every novel feature and novel combination of features herein disclosed.

Those skilled in the art will appreciate that the invention described herein is susceptible to variations and modifications other than those specifically described. It is understood that the invention includes all such variations and modifications which fall within the spirit and scope.

1. A treatment solution for extending the shelf life of an exposed edible plant structure when impregnated into the exposed edible plant structure, the treatment solution comprising at least one antioxidant, at least one mineral salt, and at least one organic acid.

2. A treatment solution according to claim 1 in which the anti-oxidant is selected from erythorbic acid, sodium erythorbate, ascorbic acid, ascorbate salts, sodium ascorbate, calcium ascorbate, potassium ascorbate, or a mixture thereof.

3. A treatment solution according to claim 1 in which the mineral salt is selected from calcium chloride, sodium acid pyrophosphate or a mixture thereof.

4. A treatment solution according to claim 1 in which the organic acid is selected from acetic acid, citric acid, lactic acid or a mixture thereof.

5. A treatment solution according to claim 1 which comprises between 0.1 to 5% sodium acid pyrophosphate and 0.1 to 10% citric acid, 0.1 to 15% ascorbic acid and 0.01 to 2% calcium chloride.

6. A treatment solution according to claim 1 which includes between 1 to 2% sodium acid pyrophosphate, 1 to 5% citric acid, 2 to 6% ascorbic acid and 0.1 to 0.5% calcium chloride.

7. A process for treating an exposed edible plant structure, comprising the steps of:
applying the treatment solution according to claim 1 to an exposed edible plant structure; and
impregnating the treatment solution into the exposed edible plant structure,
thereby producing a treated edible plant structure having an extended shelf life.

8. A process for treating an exposed edible plant structure according to claim 7 in which step of applying the treatment solution occurs simultaneously with the step of impregnating the treatment solution.

9. A process for treating an exposed edible plant structure according to claim 7 in which the treatment solution is impregnated into the treated exposed plant structure using a partial vacuum means which creates a partial vacuum around the exposed plant structure.

10. A process for treating an exposed edible plant structure according to claim 9 in which the partial vacuum means applies a pressure less than −0.8 bar at the surface of the edible plant structure.

11. A process for treating an exposed edible plant structure according to claim 10 in which the partial vacuum means applies a pressure between −0.9 bar and −0.99 bar at the surface of the edible plant structure.

12. A process for treating an exposed edible plant structure according claim 7 in which the treatment solution is applied to the edible plant structure for a time period of up to 15 minutes.

13. A process for treating an exposed edible plant structure according to claim 7 in which the treatment solution is applied to the edible plant structure for a time period between 2 to 10 minutes.

14. A process for treating an exposed edible plant structure according to claim 7 further comprising the step of sealing the treated edible plant structure within a container substantially free of oxygen.

15. A process for treating an exposed edible plant structure according to claim 14 in which the treated edible plant structure is sealed within a container using a further process comprising the steps:
placing the treated edible plant structure into a container;
creating a partial vacuum in the container so as to substantially remove any oxygen surrounding the treated edible plant structure; and
sealing the container,
thereby sealing the treated edible plant structure into a container substantially free of oxygen.

16. A process for treating an exposed edible plant structure according to claim 15 in which partial vacuum also assists in impregnating the treatment solution into the plant structure.

17. A process for treating an exposed edible plant structure according to claim 15 in which the partial vacuum is applied so that a pressure of less than −0.8 bar occurs inside the container prior to sealing.

18. A process for treating an exposed edible plant structure according to claim 17 in which the partial vacuum is applied so that a pressure of between −0.9 bar and −0.99 bar occurs inside the container prior to sealing.

19. A process for treating an exposed edible plant structure according to claim 14 in which the treated edible plant structure is sealed within a container using a further process comprising the steps:
placing the treated edible plant structure into a container;
substantially displacing/replacing air in the container with a non-oxygen containing gas; and
sealing the container,
thereby sealing the treated edible plant structure into a container substantially free of oxygen.

20. A process for treating an exposed edible plant structure according to claim 7 carried out under controlled temperature conditions between 10 to 15° C.

21. A process for treating an exposed edible plant structure according to claim 7 in which the edible plant structure is initially brought to a temperature between 10 to 15° C. prior to the treatment process.

22. A process for treating an exposed edible plant structure according to claim 7 further comprising the step of substantially cooling the treated edible plant structure.

23. A process for treating an exposed edible plant structure according to claim 22 in which the treated edible plant structure is cooled to a temperature less than 15° C.

24. A process for treating an exposed edible plant structure according to claim 22 in which the treated edible plant structure is cooled to less than 5° C. over a time period between 8 to 30 hours.

25. A process for treating an exposed edible plant structure according to claim 22 in which the treated edible plant structure is cooled to 8° C. in less than 5 hours and thereafter cooled to less than 5° C. in less than 19 hours.

26. A process for treating an exposed edible plant structure according to claim 7 in which the edible plant structure is at least one potato.

27. A process for treating an exposed edible plant structure, comprising the steps of:
applying the treatment solution according to claim 1 to an exposed edible plant structure;
creating a partial vacuum around the exposed edible plant structure thereby impregnating the treatment solution into the exposed edible plant structure thereby forming a treated edible plant structure;
sealing the exposed edible plant structure into a container substantially free of oxygen; and
substantially cooling the treated edible plant structure
thereby producing a treated edible plant structure having an extended shelf life.
